(19) United States
(12) Patent Application Publication
(10) Pub. No.: US 2005/0098054 A1
(43) Pub. Date: May 12, 2005

(54) Method of and device for producing information carriers, for example cards

(76) Inventors: Anders Berndtsson, Kullavik (SE); Stefan Kempter, Stockach-Espasingen (DE)

Correspondence Address: STRIKER, STRIKER & STENBY, 103 East Neck Road, Huntington, NY, 11743, US

(21) Appl. No.: 10/808,116

(22) Filed: Mar. 24, 2004

(30) Foreign Application Priority Data
Nov. 8, 2003 (EM) 030 25586.3

(51) Int. Cl. B41C 1/00; B41M 1/00

(52) U.S. Cl. 101/483

(57) ABSTRACT

For producing information carriers the information carriers are transported by at least one transporting device; processing a surface of the information carriers by is processed a processing unit; and the information carriers are treated on the surface so that the surface is well wetted for further printing with ink; and an apparatus for producing the information carriers is provided as well.

### BACKGROUND OF THE INVENTION

The present invention relates to a method of producing information carriers, such as for example cards, as well as to a device for performing the method.

In methods of producing information carriers it is desired to produce a printing image which as sharp and clean as possible during printing of the information carrier. Moreover, a high efficiency, for example a high throughput of substantially 40,000-50,000 of the information carriers per hour is desired. Also, the treatment of the information carriers in high quantities must be disturbance-free and reliable to provide a reproducible quality, and simultaneously the required expenses must be as low as possible.

### SUMMARY OF THE INVENTION

It is therefore an object of the present invention to provide a method for producing information carriers which is performed so that a sharp and clean printing image is produced and in addition, with a great transportation capacity and a great throughput, a reliable, disturbance-free processing is guaranteed during transportation of the information carriers.

In keeping with these objects and with others which will become apparent hereinafter, one feature of the present invention resides, briefly stated, in a method for producing information carriers, comprising the steps of transporting the information carriers by at least one transporting device; processing a surface of the information carriers by a processing unit; and treating the information carriers on the surface so that the surface is well wetted for further printing with ink.

With this treatment of the surfaces of the information carriers to be printed a good and sharp printing image is obtained and simultaneously disturbances are avoided. The method stages for this treatment can be an independent stage following the production of the information carriers. It can also be a treatment stage which follows the further treatment stage, which for example can be turned off. Instead, it can be also a treatment step which follows the further treatment steps, which for example turned off. Furthermore, these process steps can also be joined with some actions, which for example can be performed during the supply of the information carriers.

In accordance with a further feature of the present invention, the information carrier is printed with ink on a surface, in particular on its upper surface. The printing of the information carriers with ink in this manner can be an independent processing stage or also a further processing stage, which for example follows the stages of the treatment. Because of this treatment of the print with ink, in particular in accordance with the DoD process, reliably a clean and sharp printing image is obtained.

A further independent inventive solution is provided when the information carrier is guided along at least one-sided guide and forwarded by a transporting device at a distance above a band or a chain. In this case an especially simple and reliable transportation of the information carriers is provided.

In accordance with a further feature of the present invention, the speed of the information carriers during movement along a treatment unit, in particular a treatment unit for printing can be measured, the position of the information carrier can be detected, a treatment unit can be controlled in dependence on a measured speed, etc. In this case the obtained printing image is further improved.

In accordance with a further feature of the present invention, after printing of the information carrier with ink, the information carrier is advanced to at least one treatment unit for drying or hardening of the ink. Thereby a reliable drying or hardening of the ink is obtained.

The present invention also deals with a device for producing information carriers, for example cards, which includes at least one treatment unit for treating a surface of an information carrier with ink, in particular in accordance with DoD process, and at least one treatment unit for drying or hardening of the ink.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic view of a device for producing information carriers in accordance with the present invention;

FIG. 2 is a schematic side view of a detail II in FIG. 1 of the inventive device on an enlarged scale;

FIGS. 3 and 4 are schematic plan views of parts of an initial region III and an end region IV in FIG. 2;

FIG. 5 is a view showing a schematic section taken along the line V-V in FIG. 3 through the inventive device; and

FIG. 6 is a schematic side view of a treatment unit for direct speed measurement of the device in FIG. 1 in accordance with the present invention.

### DESCRIPTION OF THE PREFERRED EMBODIMENTS

The drawings schematically show a device 10 for producing any information carriers 11, which can be composed of different materials, for example textiles, paper, synthetic plastic, wood, metal, etc. These information carriers 11 can be composed of a flexible material, and also placed in form of rolls or sheets. It can be advantageous when the information carriers 11 are somewhat bending-resistant, so that they can be moved forwardly by means of at least one transporting device 12 between at least one-sided or two-sided guides 13 and 14 in a transporting direction according to arrow 15 and thereby displaced forwardly. The information carriers 11 can be in particular cards, and the cards of any types, for example credit cards, telephone cards, customer cards, bank cards, etc. provided with corresponding informations.

The information carriers 11 are processed with the device 10 so that they are processed on a surface 16 for example on the upper surface. This processing can be provided in several successively following processing stages, while the information carriers 11 are movable forwardly to individual stationary processing units. Instead, the processing of the information carriers can be performed in one operational stage and therefore by means of only one processing unit.

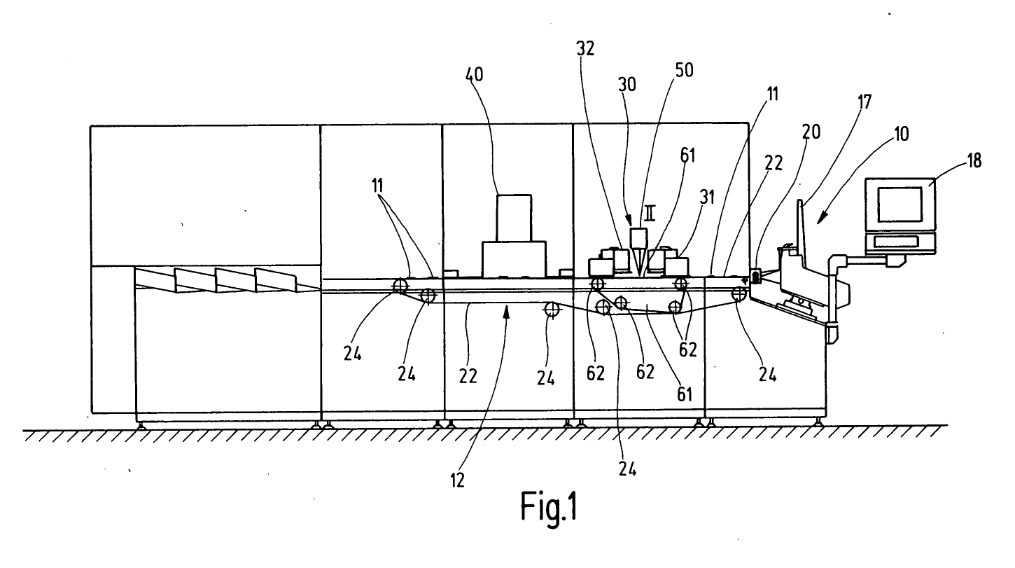

In the shown embodiment the device 10 for the treatment of the surface 16, in particular the upper surface of the individual information carriers 11 has at least one processing unit 20 which is schematically shown in FIG. 1 and provided for treating of the surface 16 for increasing the wetting ability of the ink and/or at least one further processing unit 30 for printing with ink, in particular in accordance with the DoD process (Drop on Demand Process) and/or at least one processing unit 40 for drying or hardening of the ink. When the device in the shown example has both the at least one processing unit 20 and also the at least one processing unit 30, then the at least one processing unit 20 for treatment is arranged along the transporting path in accordance with arrow 15, for example before the at least one processing unit 30. When the device 10 in correspondence with the shown embodiment has both processing units 30 and 40, then the at least one processing unit 40 for drying or hardening of the ink is arranged along the transporting path in accordance with the arrow 15 for example after the at least one processing unit for printing.

The device 10 further has a feeder 17 which is arranged at the beginning and shown schematically. The information carriers 11 are inserted and stacked in the feeder 17, and thereafter are withdrawn from below the stack and transferred to the transporting device 12 so as to be transported by the latter through the device 10. The device 10 is controlled by at least one control device 18 which operates for controlling of the individual processing units and corresponding elements and supplies all informations and data which are required for the production of the information carriers 11 in a conventional way.

In accordance with a not shown, advantageous embodiment, the at least one processing unit 20 can be contained in the feeder 17 or arranged before it.

In accordance with the shown embodiment, the at least one processing unit 30 which is provided for printing has at least one or several printing heads 31, 32 which are spaced from one another, for example along the transporting path in accordance with arrow 15, and formed for example as DoD printing heads.

The device 10 further has at least one further processing device 50 for contactless direct speed determination of the information carriers 11, which for example is associated with the processing unit 30 for printing. The processing device 50 determines the speed of the transporting information carriers 11, and operates in particular for example in accordance with the differential Doppler principle.

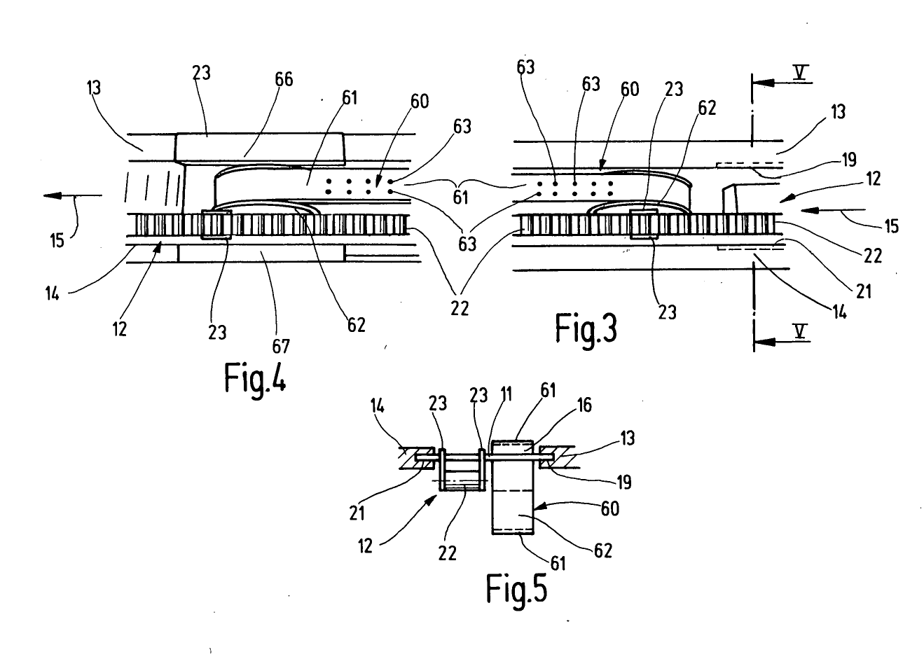

Before explaining the details of the manufacturing process, it should be mentioned that FIGS. 3-5 illustrate the transporting device 12 which instead of one-sided guide, has two-side guides 13 and 14 extending substantially parallel to one another and running at a distance which is sufficient for receiving the individual information carriers 11 between them, to hold them from lifting upwardly and from falling downwardly, and to move forwardly one after the other in the transporting device according to the arrow 15. The guides 13 and 14 are provided for example with longitudinal grooves 19, 21 formed as a lying letter U, for displaceably guiding the information carriers 11 at their both sides extending substantially parallel to the transporting direction according to the arrow 16. The transporting device 12 further has a transporting chain 20 or a corresponding band running between the guides 13, 14 and underneath the transporting plane of the information carriers 11. The transporting chain 22 carries drivers 23 provided for example at both longitudinal sides and extending upwardly over the upper side of the upper run of the chain 22, so that the drivers 23 abut at the rear edge of the individual information carriers 11 and during revolving of the chain 22 drive the information carriers 11 and move them forward. The drivers 23 are arranged at such distances along the transporting direction according to the arrow 15, which is greater than the length of the information carriers measured in the same direction. As shown in FIG. 1, the chain 22 or the band in this embodiment is guided over deviating rolls 24 and driven in a revolving fashion.

In the region of the at least one processing unit 30 for printing, a separate transporting device 60 is provided, which is associated with the processing unit 30 and incorporated in the transporting device 12. The transporting device 60 is operative for taking the information carriers at the entrance III from the transporting device 12, to somewhat lift them upwardly, to guide them through the processing unit 30 and to insignificantly lower them at the exit IV, and again to transfer them to the transporting device 15. The transporting device 15 guarantees a precise guidance of the information carriers 11 during the passage through the processing unit 30 for printing, and thereby guarantees a precise printing of the surface 16. By means of the transporting device 60 the condition is taken into consideration, that during DoD process the active side of the processing unit 30, in particular the printing heads 31, 32, must be arranged with a very small distance directly over the surface 16 to be printed of the information carriers 11. By lifting the information carriers 11 in the region of the processing unit 13, it is prevented that during running of the band or the chain 22 their drivers 30 in the region of the processing unit 30 strike in particular against the printing heads 31, 32. By means of this separate transporting device 60, the information carriers 11 before reaching the processing unit 30 are transferred, being released from the transporting device 12 in particular from its guides 13, 14, transported further in the transporting direction according to the arrow 15, and after passing the processing unit 30 are again transferred to the transporting device 12, in particular its guides 13, 14.

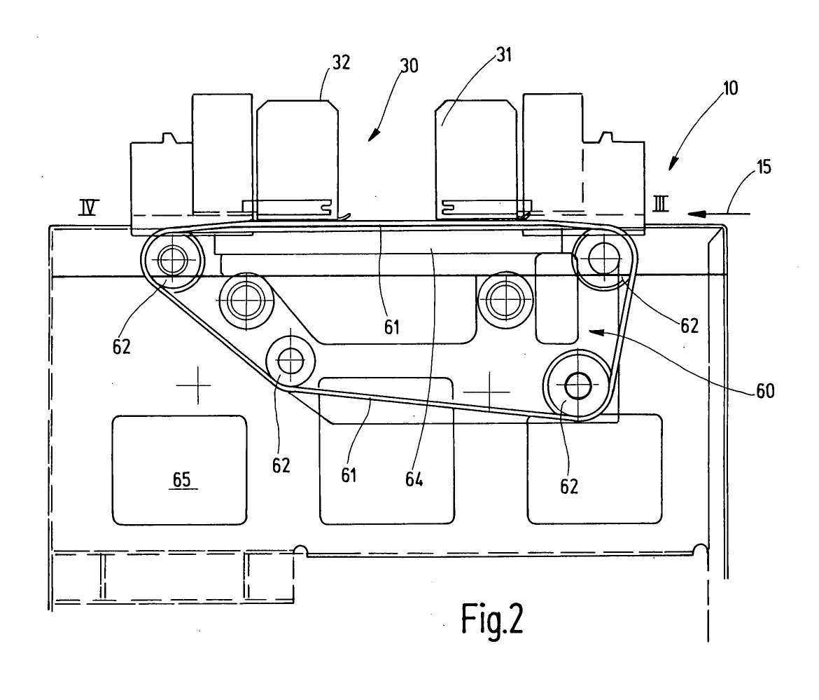

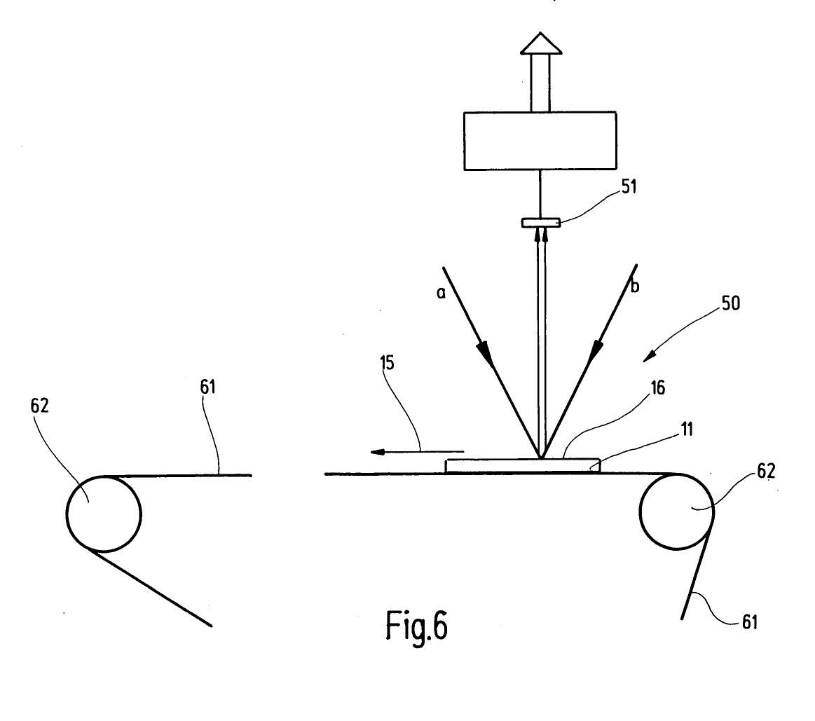

The transporting device 60 has for example a revolving transporting band 61 which is guided over deviating rolls 62, with for example one roller operating for driving the transporting band 61. The transporting band 61 can be provided with openings 63, through which the upper movable run of the transporting band 61 (FIGS. 2 and 6) communicates with a vacuum device 64 located under it, for example a suction chamber. Therefore a vacuum acts on the information carriers 11 located on the transporting band 61 through the openings 63 and reliably hold them on the upper side of the transporting band 61. The vacuum device 64 for example has a vacuum pump 65 as well as corresponding connection conduits which are not shown. The information carriers 11 which are transferred to the transporting band 61 lie on the upper side of the transporting band 61 and run at the distance above the guiding plane of the transporting device 12 which is defined by the guides 13, 14, in particular by their longitudinal grooves 19, 21. The information carriers 11 move at this elevated level through the processing unit 30 for printing.

The longitudinal grooves 19, 21 of the guides 13, 14 end at a distance before the entrance III of the transporting band 61 as shown in FIG. 3. The guides 13, 14 are open at least at an upper side so that the information carriers 11 can be lifted upwardly from the longitudinal grooves 19, 21. The information carriers 11 are thereby released in the region of the entrance III from the transporting device 12 and taken by the transporting device 16 in particular its transporting band 61, and then moved with it through the processing unit 30. In the region of the end of the transporting band 61 shown in FIG. 4, in the guides 13, 14 the longitudinal grooves 19, 21 are extended so that the information carriers 11 can be moved in them further. First the information carriers 11 are directed by upper-side directing elements 66, 67 in FIG. 2 downwarldy, so that they can run into the longitudinal grooves 19, 21.

The speed of the transporting band 61 is selected greater, for example by substantially 5%, than the speed of the chain 22 of the transporting device 12. Thereby in the region of the exit IV of the information carriers 11 it is guaranteed that they are transferred reliably and reproducibly from the drivers 23 again into the chain circulation.

The at least one processing unit 20 for treatment of the surface 16 of the information carriers 11 is such a processing unit, with which the information carriers 11 are treated on the surface 16 so that the surface 16 during further printing with ink, for example by means of the at least one processing unit 30, is well wetted, so that in particular its wetting ability is increased and thereby the later printed image is improved. The treatment with the at least one processing unit 20 is performed so that the surface energy of the surface 16 of the information carriers 11 is increased and in particular is increased so that it is greater than the surface tension of the ink which serves for later printing. The surface 16 of the information carrier 11 is oxidized and ionized during this treatment. In particular, the surface 16 of the information carriers 11 can be subjected by the processing unit 20 to a corona treatment. Instead, in accordance with another embodiment the processing unit 20 is designed so that it subjects the surface 16 of the information carriers 11 to a thermal treatment, for example by means of open flame, such as a gas flame and the like. Instead, also a plasma treatment can be performed.

Since this treatment of the information carriers 11 with the at least one processing unit 20 serves for improving of the later print, it is advantageous when this treatment is a treatment stage on the transporting path of the information carriers 11 in the transporting direction 15 or it is a component of the feeding. For this treatment by means of the at least one processing unit 20 the following concepts have to be taken into consideration. The information carriers 11 are printed by the device 10 in the region of the surface 16, in particular on the upper surface, by a special ink which makes possible the utilization of the DoD process in a disturbance-free manner. For this purpose such an ink is utilized, which at least substantially is free from solvents, at least volatile solvents. Such an ink has the advantage that in the ink droplets which are produced on the nozzle outlet opening of the printing heads 31, 32 no solvent is contained which can evaporate before the exit, so that the ink located in the head dries and in this condition clogs the nozzle outlet openings. The use of such inks, which are at least substantially free from solvents, at least volatile solvents, also eliminates the danger of clogging of the nozzle outlet openings in the individual nozzles of the corresponding printing heads 31 and 32.

Such advantageous inks however have a greater surface tension than solvent-containing inks, in which the surface tension is more or less determined by the solvent. This high surface tension of the ink which is used in DoD processes brings the danger that the surfaces to be printed are insufficiently wetted with the ink and therefore produce an inadequate printing image. With the treatment of the surfaces 16 of the information carriers 11 performed by at least one processing unit 20, this is taken into consideration and the wettability with ink is increased by increasing the surface energy. The surface energy is increased so that it is greater than the surface tension of the used ink.

The printing of the surfaces 16 of the information carriers 11 is performed with such an ink which is hardened by polymerization and in particular is dried under the action of the UV-radiation, electron radiation, thermal treatment, etc. When a UV-hardenable ink is used, then after printing the treatment with UV-radiation must be performed with such intense UV-light whose emission spectrum is determined by the ink. The at least one processing unit 40 which serves for drying or hardening of the ink is composed for example of at least one UV-lamp in case of the desired action with UV-radiation. It can be advantageous when several UV lamps are provided. They can be arranged and/or selected with respect to their spectrum so that an increase of the intensity is performed and/or different spectra are covered.

In the shown embodiment the printing of the surfaces 16 of the information carriers 11 is a further treatment stage, which is performed at the treatment stage in form of the treatment by means of the at least one processing unit 20.

As shown specifically in FIG. 5, the information carriers 11 during the transportation in the transporting direction 15 with the transporting device 12 are not located on the upper side of the band or chain 22 but instead the latter with the drivers 23 serves for the dragging movement of the information carriers 11 which are moved forwardly at a distance above the band or the chain 22. In the course of the forward transportation and for passing through the at least one processing unit 30 for printing, the information carriers 11 are transferred from the transporting device 20 onto the other transporting device 60 associated with the processing unit 30 and after passing through the processing unit 30 they are transferred from the transporting device 60 again to the transporting device 12. Since the transporting speed of the information carriers 11 during transportation by means of the separate transporting 60 is greater than that of the transportation by means of the transporting device 12, in the transfer region IV a disturbance-free transfer in the guides 13, 14, in particular longitudinal grooves 19, 21 and a driving by means of the drivers 23 of the band or of the chain 20 are guaranteed. Since the information carriers 11 during the transfer from the transporting device 12 to the transporting device 60 are released from the guides 13, 14 and at least insignificantly moved up to the level of the upper side of the transporting band 61, it is guaranteed that the information carriers 11 are moved forwardly with only a very small distance from the active side of the processing unit 30 for printing, in particular from the printing head 31, 32, and the printing heads do not come into contact with the drivers 23 and no collision occurs. The information carriers 11 are lifted so far that they are located outside of the range of the drivers 23.

During printing of the information carriers 11 the at least one processing unit 50 for speed determination determines the speed of the information carriers 11 moved relative to the stationary printing heads 31, 32, by direct contactless sensing of the information carriers 11 and in the immediate vicinity to the at least one processing unit 30. Furthermore, at least one not shown position sensor can be provided, with which the position of the information carriers 11 during the movement along the processing unit 30 can be detected. In correspondence with the determined speed of the information carriers 11 together with the information of the position sensor, the at least one processing unit 30 for printing is controlled. This has the advantage that a good printing image is obtained by printing. For producing a predetermined printing image, the speed of the information carriers 11 at each time point must be known exactly, so that together with the information of the position sensor it is possible to calculate when exactly an ink droplet must leave a printing nozzle, with the printing heads 31, 32 of the processing unit 30 operating in accordance with the DoD process.

It is possible to determine the speed of the information carriers 11 by at least one rotary sensor, in particular a rotary sensor which is driven by the transporting device 60, for example a deviating roll 62. Because of the thusly performed indirect speed measurement several tolerances can be linked which can lead to a worse printed image, since the individual ink droplets do have for example a concrete phase length relative to one another. By means of a rotary sensor the speed is not determined at the place of the print, but instead on another place which is farther spaced from it, whereby the speed determination is also not very accurate.

Contrary to this, the at least one processing unit 50 provides the advantage that the speed of the information carriers 11 can be determined directly by direct contactless sensing and in the immediate vicinity to the printing heads 31, 32. This processing unit 50 advantageously can operate in accordance with a differential Doppler principle. In the shown embodiment the speed measurement of the information carriers 11 is a treatment stage which is associated with the printing. The information carriers 11 are advanced during their movement by the separate transporting device 60 through the at least one processing unit 30 for printing, to the processing unit 50, by means of the direct speed determination. The at least one processing unit 50 in FIG. 1 is placed between the spaced printing heads 31, 32. Instead it can be also placed before the printing heads 31, 32.

The details of the at least one processing unit 54 speed determination in accordance with a differential Doppler principle are illustrated in FIG. 6. The direct speed determination is performed in the immediate vicinity to the place where the printing is carried out. The differential Doppler principle is known. A laser beam produced by a not shown laser source is split into two components a and b, which act relatively steeply on the measuring surface 16. One beam b has a directional component extending parallel in the transporting direction according to the arrow 13 to the information carriers 11. The other beam a to the contrary has a directional component which is directly opposite to the transporting direction according to the arrow 15 of the information carriers 11. Due to the Doppler effect, in the case of the reflection of both beams a, b the corresponding frequency shift has the same amount, but because of the differently oriented speed components with different signs, wherein the amount of the frequency shift is proportional to the speed of the information carriers. The reflected component of both beams a, b reaches a photodiode 51 where a mixing process of both components takes place. At the output of the photodiode 51, a low frequency signal is produced with exactly doubled frequency shift. By the measurement of the frequency of this signal thereby directly the speed of the information carriers 11 can be determined.

This at least one processing unit 50 operating for speed determination is not shown specifically in FIG. 2, but instead is schematically identified in FIG. 1.

The device 10 and the described method for producing information carriers 11 has many advantages. The device 10 is simple, small, compact and cost-favorable. The device 10 has a very high efficiency of for example 40,000-50,000 information carriers per hour or more. The device 10 is suitable for modular assembly of components in great quantities, since for example only at least one processing unit 20 for treatment and/or the at least one processing unit 30 for printing and/or the at least one processing unit 40 for drying or hardening of the ink can be provided, depending on the requirements of the consumer. It is further advantageous that the device operates substantially reliably and the printing with very good, in particular very sharp pressure images with the information carriers 11 are possible.

It will be understood that each of the elements described above, or two or more together, may also find a useful application in other types of constructions and methods differing from the types described above.

While the invention has been illustrated and described as embodied in method of and device for producing information carriers, such cards, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method for producing information carriers, comprising the steps of transporting the information carriers by at least one transporting device; processing a surface of the information carriers by a processing unit; and treating the information carriers on the surface so that the surface is well wetted for further printing with ink.

2. A method as defined in claim 1; and further comprising performing the treating so that wettability with ink is increased and a later produced printed image is improved.

3. A method as defined in claim 1; and further comprising performing the treating so that a surface energy of the surface of the information carriers is increased.

4. A method as defined in claim 3; and further comprising increasing the surface energy so that it is greater than a surface tension of the ink for printing.

5. A method as defined in claim 1; and further comprising oxidizing the surface of the information carriers by the treating.

6. A method as defined in claim 1; and further comprising subjecting the surface of the information carriers to an ionization.

7. A method as defined in claim 1; and further comprising subjecting the surface of the information carriers to a corona treatment.

8. A method as defined in claim 1; and further comprising subjecting the surface of the information carriers to a thermal treatment.

9. A method as defined in claim 8; and further comprising performing the thermal treatment by an open flame.

10. A method as defined in claim 8; and further comprising performing the thermal treatment by a gas flame.

11. A method as defined in claim 1; and further comprising subjecting the surface of the information carriers to a plasma treatment.

12. A method as defined in claim 1; and further comprising performing the treatment of the surface of the information carriers as a treatment stage on a transporting path.

13. A method as defined in claim 1; and further comprising advancing the information carriers on their transporting path to at least one processing unit which performs the treatment.

14. A method for producing information carriers, comprising the steps of forwarding the information carriers by at least one transporting device; moving the information carriers to at least one processing unit for processing on a surface of the information carriers; and printing the information carriers on the surface with ink.

15. A method as defined in claim 14; and further comprising performing the printing with ink in accordance with a DoD process.

16. A method as defined in claim 14; and further comprising performing the printing with such an ink which is substantially free of solvents.

17. A method as defined in claim 14; and further comprising performing the printing with such an ink which is substantially free of volatile solvents.

18. A method as defined in claim 14; and further comprising performing the printing with such an ink which is hardened by polymerization.

19. A method as defined in claim 14; and further comprising performing the printing with such an ink which is dried or hardened by an action selected from a group consisting of UV radiation, electron radiation, and thermal action.

20. A method as defined in claim 14; and further comprising performing the printing of the surface of the information carriers as a further processing stage on a transporting path.

21. A method as defined in claim 14; and further comprising advancing the information carriers on their transporting path to at least one processing unit which performs printing.

22. A method as defined in claim 21; and further comprising providing the at least one processing unit for printing with at least one printing head.

23. A method as defined in claim 22; and further comprising using a DoD printing head as said at least one printing head.

24. A method as defined in claim 1; and further comprising a further treatment stage which serves for printing of the surface of the information carriers and which follows the treatment stage along a transporting path of the information carriers.

25. A method as defined in claim 14; and a further comprising a further treatment stage which serves for printing of the surface of the information carriers and which follows the treatment stage along a transporting path of the information carriers.

26. A method of producing information carriers, comprising the steps of forwarding information carrier by at least one transporting device; moving the information carriers to a processing unit for processing on a surface of the information carriers; guiding the information carriers along at least one-sided guide in a longitudinal groove; and moving along with the transporting device drivers which abut against and drive the information carriers at a distance above a transporting element selected from the group consisting of a band and a chain.

27. A method of producing information carriers, comprising the steps of forwarding the information carriers by a transporting device; moving the information carriers to at least one processing unit for printing on a surface of the information carriers; transferring the information carriers in a course of a forward movement and for passing the processing unit for printing to a further transporting device associated with the processing unit, and after passing through the processing unit transferring the information carriers from the further transporting device again to the transporting device.

28. A method as defined in claim 27; and further comprising selecting a transporting speed of the information carriers movable by the further transporting device greater than a transporting speed of the information carriers movable by the transporting device.

29. A method as defined in claim 28; and further comprising selecting the transporting speed of the information carriers movable by the further transporting device substantially 5% greater than that of the information carriers movable by the transporting device.

30. A method as defined in claim 27; and further comprising providing in the further transporting device a revolving transporting band provided with holes through which the information carriers are acted upon by a vacuum to hold the information carriers on the transporting band.

31. A method as defined in claim 30; and further comprising moving by the transporting band the information carrier with a small distance from an active side of an associated processing unit for printing.

32. A method as defined in claim 27; and further comprising releasing information carriers from guides of the transporting device for transfer to the further transporting device, lifting the information carriers at least insignificantly, and transferring to a transporting band of the further transporting device.

33. A method as defined in claim 26; and further comprising at least insignificantly moving the information carriers downwardly for transferring back to the transporting device, inserting the information carriers into the guides, and then taking the information carriers the information carriers by drivers of the transporting device.

34. A method as defined in claim 27; and further comprising at least insignificantly moving the information carriers downwardly for transferring back to the transporting device, inserting the information carriers into guides, and then taking the information carriers by drivers of the transporting device.

35. A method of producing information carriers, comprising the steps of forwarding the information carriers by at least one transporting device; moving the information carriers to a processing unit for printing on a surface of the information carriers; measuring a speed of the information carriers during the movement along the processing unit for printing.

36. A method of producing information carriers, comprising the steps of forwarding the information carriers by at least one transporting device; moving the information carriers to a processing unit for processing of a surface of the information carriers; determining a position of the information carriers by at least one position sensor during a movement along the processing unit for printing.

37. A method as defined in claim 35; and further comprising controlling the at least one processing unit for printing in correspondence with a measured speed of the information carriers together with an information of the position sensor.

38. A method as defined in claim 36; and further comprising controlling the at least one processing unit for printing in correspondence with a measured speed of the information carriers together with an information of the position sensor.

39. A method as defined in claim 35; and further comprising determining a speed of the information carrier by direct contactless sensing of the information carriers in immediate vicinity to the processing unit for printing.

40. A method as defined in claim 36; and further comprising determining a speed of the information carrier by direct contactless sensing of the information carriers in immediate vicinity to the processing unit for printing.

41. A method as defined in claim 35; and further comprising using a differential Doppler principle for determining a speed of the information carriers.

42. A method as defined in claim 36; and further comprising using a differential Doppler principle for determining a speed of the information carriers.

43. A method as defined in claim 35; and further comprising determining the speed of the information carriers by at least one rotary sensor driven by a further transporting device.

44. A method as defined in claim 36; and further comprising determining a speed of the information carriers by at least one rotary sensor driven by a further transporting device.

45. A method as defined in claim 35; and further comprising providing a speed determination of the information carriers as a processing stage associated with printing.

46. A method as defined in claim 36; and further comprising providing a speed determination of the information carriers as a processing stage associated with printing.

47. A method as defined in claim 35; and further comprising moving information carriers during movement by a further transporting device through the processing unit for printing to an additional processing unit for determining a speed.

48. A method as defined in claim 36; and further comprising moving information carriers during movement by a further transporting device through the processing unit for printing to an additional processing unit for determining a speed.

49. A method as defined in claim 35; and further comprising using for determining a speed of the information carriers a processing unit which is located near or before printing heads.

50. A method as defined in claim 36; and further comprising using for determining a speed of the information carriers a processing unit which is located near or before printing heads.

51. A method of producing information carriers, comprising forwarding the information carriers by at least one transporting device; moving the information carriers to a processing unit for processing on a surface of the information carriers; and, after printing of the information carriers with ink, advancing the information carriers to at least one processing unit for drying or hardening of ink.

52. A method as defined in claim 51; and further comprising the drying or hardening ink by an action selected from the group consisting of UV radiation, electron radiation, and thermal treatment.

53. An apparatus for producing information carriers, comprising at least one transporting device for forwarding the information carriers; and processing means for processing on a surface of the information carriers, said processing means being means selected from the group consisting of a processing unit for treating a surface of the information carriers for increasing wettability of ink, at least one processing unit for printing with ink in particular in accordance with a DoD process, and at least one processing unit for drying or hardening the ink, and combinations thereof.

54. An apparatus as defined in claim 53, wherein said at least one processing unit for treating is arranged along a transporting path of the information carriers before said at least one processing unit for printing.

55. An apparatus as defined in claim 53, wherein said at least one processing unit for drying or hardening is arranged along a transporting path of the information carriers after said at least one processing unit for printing.

56. An apparatus as defined in claim 53, wherein said at least one processing unit for printing includes at least one printing head formed as a DoD printing head.

57. An apparatus a's defined in claim 53;
and further comprising at least one processing unit for determining a speed of the information carriers in particular in accordance with a differential Doppler principle, said processing unit for determining the speed being associated with said at least one processing unit for printing.

58. An apparatus as defined in claim 57, wherein said at least one processing unit for determining the speed is arranged near or before a printing head of said processing unit for printing.

59. An apparatus as defined in claim 53, wherein said transporting device has at least one-sided guides, formed e.g. as longitudinal grooves, for displacably guiding the information carriers at their both sides that extend substantially parallel to a transporting direction.

60. An apparatus as defined in claim 59, wherein said transporting device is formed as a device selected from the group consisting of a band and a transporting chain and running between said guides and undernearth a transporting plane of the information carriers, said transporting device having upstanding drivers which abut against and drive the information carriers.

61. An apparatus as defined in claim 53, wherein in a region of the at least one processing unit for printing, a further transporting device associated with said processing unit for printing is arranged, said further transporting device taking the information carriers before reaching the at least one processing unit for printing with release from the first mentioned transporting device and said guides, transporting the information carriers, and after passing the at least one processing unit for printing again transferring the information carriers again to the transporting device and said guides.

62. An apparatus as defined in claim 61, wherein said further transporting device has a transporting band provided with throughgoing holes through which vacuum acts on the information carriers located on the transporting band and thereby holds the information carriers on the transporting band.

63. An apparatus as defined in claim 62, wherein the transporting band has an upper side which are spaced above a guiding plane of the guides.

64. An apparatus as defined in claim 59, wherein longitudinal grooves of the guides end at a distance from a beginning of the transporting band or are open above, and the information carriers are released at a side of their edges, and in a region of an end of the transporting band the longitudinal grooves continue; and further comprising directing elements associated with the longitudinal grooves and located at an upper side for guiding the information carriers into the longitudinal grooves.

65. An apparatus as defined in claim 62; and further comprising means for driving the transporting band with the speed which is greater than the speed of the transporting device.

66. An apparatus as defined in claim 62; and further comprising means for driving the transporting band with the speed which is 5% greater than the speed of the transporting device.
